(19) United States
(12) Patent Application Publication
(10) Pub. No.: US 2008/0049317 A1
(43) Pub. Date: Feb. 28, 2008

(54) Optical Element, Polarization Plane Light Source Using the Optical Element, and Display Device Using the Polarization Plane Light Source

(76) Inventors: Kazutaka Hara, Osaka (JP); Minoru Miyatake, Osaka (JP)

Correspondence Address: SUGHRUE-265550, 2100 PENNSYLVANIA AVE. NW, WASHINGTON, DC, 20037-3213, US

(21) Appl. No.: 11/664,216

(22) PCT Filed: Sep. 28, 2005
(86) PCT No.: PCT/JP05/17886

§ 371 Date: Mar. 29, 2007

(30) Foreign Application Priority Data
Sep. 30, 2004 (JP) 2004-288122
Apr. 20, 2005 (JP) 2005-122721

(51) Int. Cl. G02B 5/30

(52) U.S. Cl. 359/483

(57) ABSTRACT

The present invention provides an optical element including: a translucent resin; minute regions dispersedly distributed in the translucent resin and having a birefringence different from the translucent resin; and at lest one kind of luminous body dispersed in the translucent resin and/or the minute regions and having a particle size smaller than the emission wavelength thereof, the optical element having a plate-like shape; a polarized-light-emitting planar light source including the optical element and the excitation light source; and a display device including the polarized-light-emitting planar light source.

### FIELD OF THE INVENTION

The present invention relates to an optical element and a polarized-light-emitting planar light source using the same as well as a display device using the same. Particularly, the present invention relates to an optical element that is capable of allowing light, which results from excitation by incident light, to be emitted through at least one of front and rear sides thereof in the form of linearly polarized light having a predetermined plane of vibration, as well as a polarized-light-emitting planar light source using the same and a display device using the same.

### BACKGROUND ART

Heretofore, as a side-light type light-guiding plate used in a so-called backlight of a liquid crystal display, there is known one wherein a light emitting means made up of reflective dots containing high-reflectance pigments such as titanium oxide or barium sulfate is provided on a translucent resin plate and the light guide emits light from one of the front and rear sides of the resin plate through the light emitting means by scattering light, which is transmitted in the resin plate upon total internal reflection.

However, since the light emitted from the light-guiding plate having the above arrangement is natural light that exhibits almost no polarization characteristics, it is necessary to convert the emitted light into linearly polarized light via a polarizing plate when it is used for a liquid crystal display. Therefore, the conversion causes absorption loss of light by the polarizing plate and hence there is a problem that the utilization rate of light cannot exceed 50%.

In order to address such a problem, various backlights wherein increase in utilization rate of light is attempted by employing a polarization splitting means that produces linearly polarized light utilizing a so-called Brewster's angle or by employing a polarization converting means using a retardation plate have been proposed (see e.g., Patent Documents 1, 2, 3, 4, 5, 6, 7, 8, 9, 10, 11, 12, and 13).

However, since those conventional backlights still cannot attain a sufficient degree of polarization and are hard to control the polarization direction, there is a problem that they are of little practical use.

Thus, in order to solve the above problem, the inventors of the invention have already developed an optical element that is capable of allowing light, which results from excitation by incident light, to be emitted through at least one of the front and rear sides of the optical element in the form of linearly polarized light having a predetermined plane of vibration and also is capable of optionally controlling the polarization direction (plane of vibration) (Patent Document 14).

However, in the point of time when the optical element described in Patent Document 14 was developed, although a highly qualitative inference that it is preferable to reduce the size of the luminous body dispersed in the translucent resin and/or minute regions as far as possible in a case where non-dissolving luminous body is used (see paragraph 0026 of the specification of Patent Document 14), any specific quantitative study on the size to be reduced was not conducted at all.

For example, in Patent Document 14, an example using a powder of tris(8-quinolinolato)aluminum (generally referred to as Alq3) is disclosed but Alq3 used in the example, which is commercially available, has a particle size of several tens μm. In a case where an optical element is made using a luminous body having such a degree of particle size, it is found that lights, which results from excitation light entering the optical element and is emitted to outside of the optical element, has not necessarily a sufficient degree of polarization in some cases. Moreover, in a case where a luminous body having a particle size larger than a predetermined one is used, there are problems that defective appearance of the optical element may occur or a case where preparation of an optical element is difficult to prepare may occur. Furthermore, when it is attempted to increase a mixing ratio of the luminous body to be dispersed in the optical element, it is impossible to disperse the luminous body in a large amount, so that there is a problem that luminance cannot be effectively enhanced.

Patent Document 1: JP-A-6-18873

Patent Document 2: JP-A-6-160840

Patent Document 3: JP-A-6-265892

Patent Document 4: JP-A-7-72475

Patent Document 5: JP-A-7-261122

Patent Document 6: JP-A-7-270792

Patent Document 7: JP-A-9-54556

Patent Document 8: JP-A-9-105933

Patent Document 9: JP-A-9-138406

Patent Document 10: JP-A-9-152604

Patent Document 10: JP-A-9-293406

Patent Document 12: JP-A-9-326205

Patent Document 13: JP-A-10-78581

Patent Document 14; JP-A-2004-205953

### DISCLOSURE OF THE INVENTION

### Problems to be Resolved by the Invention

The present invention is contrived for the purpose of solving such problems in the conventional technology and an object of the invention is to provide an optical element that is capable of allowing light, which results from excitation by incident light to be emitted through at least one of the front and rear sides of the optical element in the form of linearly polarized light having a sufficient degree of polarization and that is easily prepared without occurrence of defective appearance and is capable of easily enhancing the luminance of emitted light as well as a polarized-light-emitting planar light source using the optical element and a display device using the same.

### Means of Solving the Problems

As a result of the extensive studies for solving the above problems, the present inventors have found that reduction of the particle size of the luminous body dispersed in the translucent resin and/or the minute regions to a particle size smaller than the emission wavelength thereof affords an optical element that is capable of allowing light, which results from excitation by incident light, to be emitted through at least one of the front and rear sides of the optical element in the form of linearly polarized light having a sufficient degree of polarization and that is easily prepared without occurrence of defective appearance and is capable of easily enhancing the luminance of emitted light. Thus, they have accomplished the invention.

Namely, the invention provides an optical element comprising: a translucent resin; minute regions dispersedly distributed in the translucent resin and having a birefringence different from the translucent resin; and at lest one kind of luminous body dispersed in the translucent resin and/or the minute regions and having a particle size smaller than the emission wavelength thereof, the optical element having a plate-like shape.

According to the invention, the thus arranged optical element omits the necessity to provide a special light emitting means made of reflective dots or the like on a translucent resin as before, while being capable of allowing light, which results from excitation by incident light in the optical element (the luminous body), to be emitted to the outside in the form of linearly polarized light having a predetermined plane of vibration. Also, the optical element of the invention can optionally set the polarization direction (plane of vibration) of linearly polarized light according to the installation angle of the optical element (according to which direction is designated as a Δn1 direction hereinafter described).

More specifically, most of the light, which results from excitation by excitation light entering the optical element through a lateral side or front or rear side thereof, is totally reflected at an air interface according to the refractive index difference between the optical element and air; and transmitted within the optical element. Of the transmitted light, a linearly polarized light component having a plane of vibration parallel to the axial direction (the Δn1 direction) of the minute regions, along which direction a maximum difference (Δn1) in refractive index between the minute regions and the transparent resin occurs, is selectively and strongly scattered. Of the scattered light, light scattered at an angle smaller than the total internal reflection angle is emitted from the optical element to the outside (air).

Herein, in a case where no minute regions are dispersedly distributed in the translucent resin, since such selective scattering of polarized light does not occur, of the light resulting from excitation by the luminous body in the optical element, about 80% of light is confined within the translucent resin and repeats the total reflection on the relationship with the solid angle.

According to the invention, the light confined within the optical element is emitted to the outside of the optical element only in a case where the total reflection condition has been broken due to scattering at the interface between the minute regions and the translucent resin. Thus, it is possible to optionally control the light emission efficiency according to the size of each minute region, distribution ratio of the minute regions, or the like.

On the other hand, light scattering at an angle larger than the total reflection angle in the above Δn1 direction, light colliding with no minute regions, and light having a plane of vibration in a direction other than the Δn1 direction are confined within the optical element and transmitted therethrough as repeating the total reflection, with waiting a chance for emission by eliminating a polarized state owing to the birefringent phase difference or the like within the optical element and allowing light itself to meet the Δn1 direction condition (that is, turn into linearly polarized light having a plane of vibration parallel to the Δn1 direction). These steps are thus repeated and, as a result, linearly polarized light having a predetermined plane of vibration is emitted from the optical element in an efficient manner.

Here, when the particle size of the luminous body is larger than a predetermined one, as shown in FIG. 1A, linearly polarized light (linearly polarized light having a plane of vibration parallel to the Δn1 direction) L, which results from excitation by one luminous body in the optical element and is obtained by colliding with the minute regions, meets the conditions for emission to the outside but is scattered and depolarized through collision with other luminous body before emission to the outside of the optical element. As a result, there is a possibility that the degree of polarization of the emitted light is lowered. Particularly, in this case, since length of optical path of light which is transmitted within the optical element in the form of the above linearly polarized light is relatively long and reflection/scattering are repeated two or more times, probability of colliding with other luminous body 3 before emission to the outside of the optical element is high. However, according to the invention, since the particle size of the luminous body is smaller than the emission wavelength (visible light region) thereof (therefore, smaller than the wavelength of the linearly polarized light L), as shown in FIG. 1B, the linearly polarized light L is hardly scattered by other luminous body 3 and passed through, so that a possibility of depolarization hardly exists. Namely, since light has properties as a wave, it passes through without being affected by objects smaller than its wavelength in most cases. Accordingly, the linearly polarized light can be emitted as linearly polarized light having a sufficient degree of polarization.

Moreover, since the particle size of the luminous body is smaller than its emission wavelength, the particle size of the luminous body is sufficiently small as compared with a practically assumed thickness of the optical element and hence defective appearance of protrusion of dispersed luminous body from the optical element surface does not occur. Also, at the preparation of the optical element, the luminous body may not be an obstruction for formation of the minute regions nor a starting point of breakage of the translucent resin when stretching is performed, so that its preparation is facilitated.

Furthermore, since the particle size of the luminous body is smaller than its emission wavelength, the luminance of light emitted from the optical element can be effectively enhanced. As shown in FIG. 2, this is because reduction of the particle size of the luminous body 3 to be dispersed (FIG. 2A) allows the luminous body 3 to be dispersed in a larger number as compared with the case of a large particle size (FIG. 2B) even when the same total weight of the luminous body is dispersed in the optical element. For example, under the condition of the same total weight, when the particle size of the luminous body 3 is reduced to one second, the total number of the luminous body 3 becomes eight times and the total surface area of the luminous body 3 becomes twice. Since excitation of the luminous body 3 occurs on the surface of the luminous body 3, enlargement of the total surface area for whole number of the luminous body 3 increases quantity of emitted light by just that much and, as a result, it is possible to effectively enhance the luminance of light emitted from the optical element.

As mentioned above, according to the invention, light resulting from excitation by incident light can be emitted to the outside in the form of linearly polarized light having a sufficient degree of polarization through at least one of front and rear sides, the optical element can be easily prepared without occurrence of defective appearance, and the luminance of emitted light can be easily enhanced.

Preferably, the above luminous body is an inorganic pigment.

According to such an arrangement, an inorganic pigment exhibits a high luminance of emitted light (emission efficiency) and also has an extremely high durability, so that it can be durable to long-term use. Therefore, it is possible to obtain an optical element excellent in luminance of emitted light, durability, and reliability as compared with the case using a dye-based luminous body.

The above luminous body is preferably a fluorescent pigment that absorbs ultraviolet light or visible light and emits visible light.

Alternatively, the above luminous body may be a phosphorescent pigment that absorbs ultraviolet light or visible light and emits visible phosphorescence.

In order to further reduce a possibility of depolarization, the particle size of the above luminous body is preferably not more than one fifth of the emission wavelength of the luminous body. The particle size of the luminous body is more preferably not more than one tenth of the emission wavelength of the luminous body, and further preferably not more than one fiftieth of the emission wavelength of the luminous body.

Here, in a case where the dispersed luminous body is aggregated to form an aggregate, the aggregate shows a behavior similar to the luminous body having a particle size equal to the diameter of the aggregate (see FIG. 1C). Therefore, the diameter of the aggregate formed by aggregating the above luminous body is preferably smaller than the emission wavelength of the luminous body. The diameter of the aggregate formed by aggregating the above luminous body is more preferably not more than one fifth of the emission wavelength of the luminous body, and further preferably not more than one tenth of the emission wavelength of the luminous body.

Preferably, the minute regions are made of a liquid crystalline material; a glass state material formed by cooling and fixing a liquid crystal phase; or a material Conned by crosslinking and fixing a liquid crystal phase of a polymerizable liquid crystal with an energy ray.

Alternatively, the minute regions may be made of a liquid crystal polymer that has a glass transition temperature of 50° C. or higher and exhibits a nematic liquid crystal phase at a temperature lower than the glass transition temperature of the above translucent resin.

Preferably, the following relations are satisfied:
0.03≦Δn1≦0.5
0≦≢6n2=0.03
0≦Δn3≦0.03
where, Δn1 is refractive index difference between the minute regions and the translucent resin in an axial direction of the minute regions, along which a value of the restive index difference between the minute regions and the translucent resin occurs; and Δn2 and Δn3 are the refractive index differences in an anal direction orthogonal to the axial direction along which the maximum refractive index difference occurs, respectively.

Incidentally, when a material absorbing relatively much light having the wavelength of excitation light is used as the translucent resin or the minute regions, the material absorbs the excitation light and hence emission efficiency tends to be lowered. Furthermore, when ultraviolet light is used as the excitation light, deterioration of the material may be invited owing to the absorption of ultraviolet light. Thus, the use of a material substantially absorbing no light having the wavelength of excitation light as a material of the translucent resin or the minute regions can reduce decrease in emission efficiency and deterioration of the material as far as possible. For example, in a case where the excitation light is ultraviolet light, both of the translucent resin and the minute regions are preferably made of materials that do not substantially absorb ultraviolet light. In this connection, the range of the wavelength band of the ultraviolet light may be a range commonly recognized as the wavelength band of ultraviolet light and may be the range of about 1 to 400 nm, for example. Moreover, the term “substantially absorb no ultraviolet light” means no absorption of ultraviolet light and also means that light absorption rate at the wavelength of excitation light is about 40% or less even when ultraviolet light is absorbed.

Also, according to the invention, there is provided a polarized-light emitting planar light source that includes the above optical element of the invention and an excitation light source that emits light of a wavelength that is capable of exciting a luminous body dispersed in the optical element.

Additionally, according to the invention, there is also provided a polarized-light-emitting planar light source, wherein the translucent resin and the minute regions are made of materials that substantially absorb no ultraviolet light and the light of a wavelength that is capable of exciting the luminous body dispersed in the optical element is ultraviolet light.

Preferably, the polarized-light-emitting planar light source firer includes a light guide member for guiding light emitted from the excitation light source to the optical element, the light guide member being made of a translucent material.

The exciting light source may be composed of an inorganic or organic electroluminescent element or a mercury-free fluorescent tube.

Furthermore, according to the invention, there is provided a display device that includes the above polarized-light-emitting planar light source.

### ADVANTAGEOUS EFFECTS OF THE INVENTION

According to the present invention, light resulting from excitation by incident light can be emitted to the outside in the form of linearly polarized light having a sufficient degree of polarization through at least one of front and rear sides, an optical element can be easily prepared without occurrence of defective appearance, and the luminance of emitted light can be easily enhanced.

### BRIEF DESCRIPTION OF THE DRAWINGS

FIG. 1 is a schematic view for illustrating influence of the particle size of a luminous body on scattering of light.

FIG. 2 is a schematic view for illustrating influence of the particle size of a luminous body on luminance of emitted light.

FIG. 3 is a vertical cross sectional view illustrating a schematic structure of an optical element according to one embodiment of the invention.

FIG. 4 is a vertical cross sectional view illustrating a schematic structure of a polarized-light-emitting planar light source, to which an optical element according to one embodiment of the invention has been applied.

FIG. 5 is a vertical cross sectional view partially illustrating a schematic structure of the polarized-light-emitting planar light source shown in FIG. 4 in a case where a different excitation light source is used.

FIG. 6 is a schematic view for explaining the fact that uniform light emission is apt to be obtained even if the excitation light source is a point source when an optical element according to one embodiment of the invention has been applied.

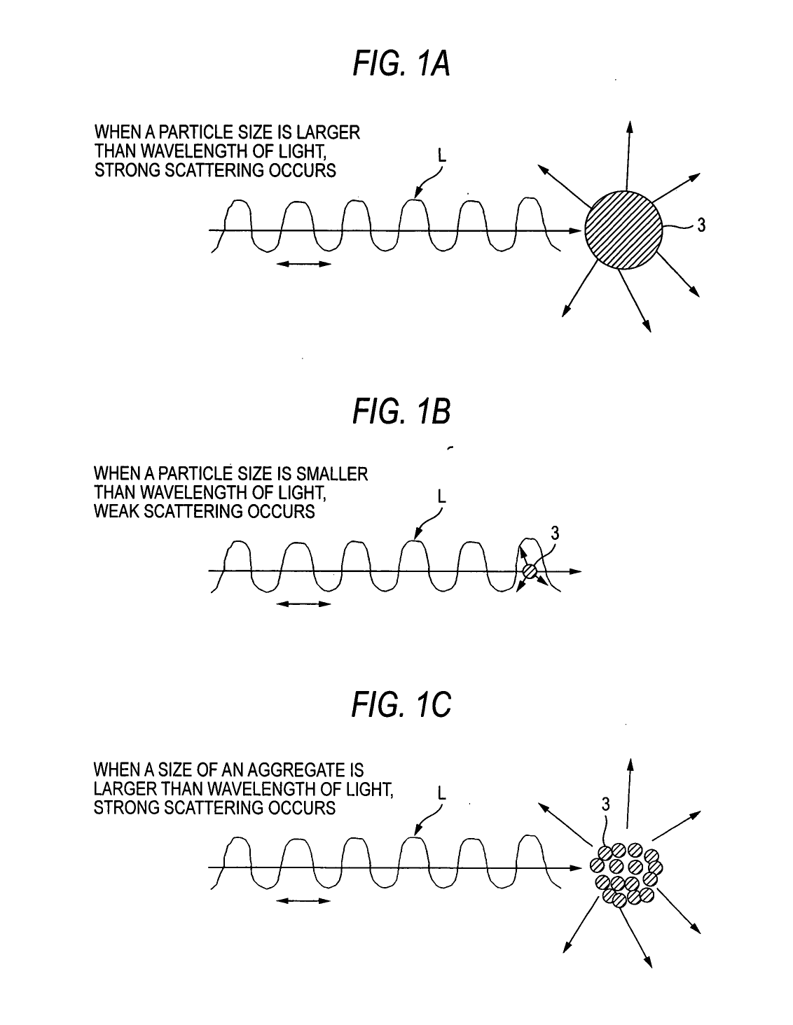

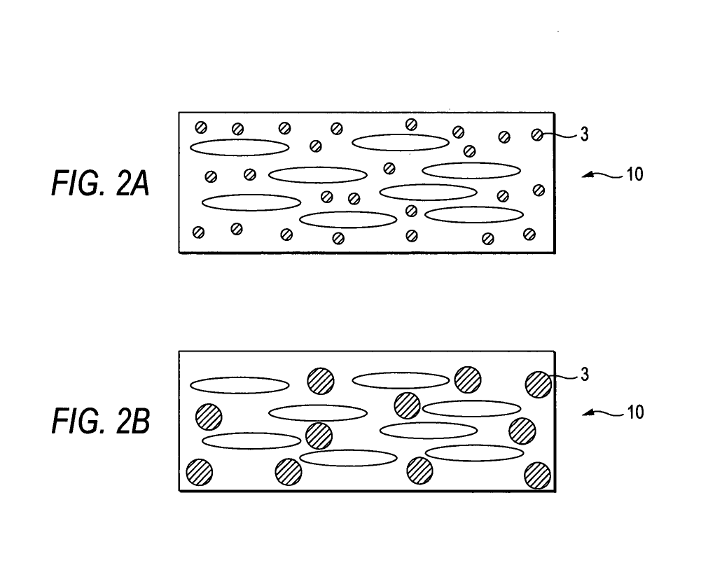

### DESCRIPTION OF THE REFERENCE NUMERALS AND SIGNS

1. translucent resin

2. minute regions

3. light-emitting material

4. translucent sheet

5. reflection layer

6. light diffusion layer

7. lens sheet

8. adhesive layer

9. excitation light source

10. optical element

### BEST MODE FOR CARRYING OUT THE INVENTION

An embodiment according to the present invention will be hereinafter described with reference to the accompanying drawings.

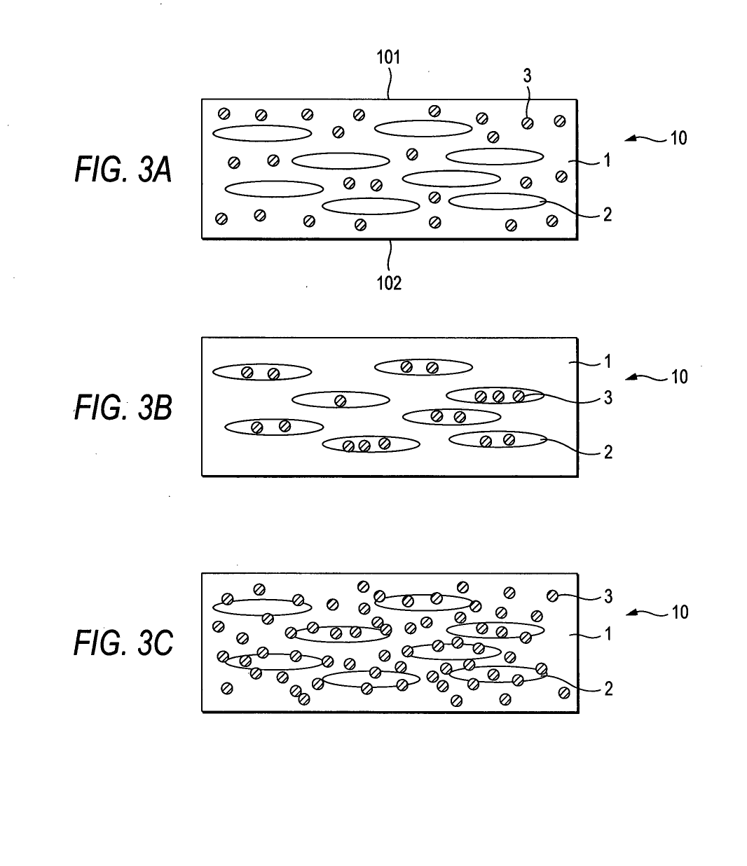

FIG. 3 is a vertical cross sectional view illustrating a schematic structure of an optical element according to one embodiment of the invention. As illustrated in FIG. 3, an optical element 10 according to this embodiment has a translucent resin 1 and minute regions 2 that are dispersedly distributed in the translucent resin 1 and have a birefringence different from the translucent resin 1, and is formed into a plate-like shape. The optical element 10 contains at least one luminous body 3 in the translucent resin 1 and/or the minute regions 2. FIG. 3A shows an example where the luminous body 3 is dispersed in the translucent resin 1, FIG. 3B shows an example where the luminous body 3 is dispersed in the minute regions 2, and FIG. 3C shows an example where the luminous body 3 is dispersed in both of the translucent resin 1 and the minute regions 2. The optical element 10 according to this embodiment may be any of the arrangements of FIG. 3A to FIG. 3C.

The optical element 10 is not necessarily formed into a specific shape, as far as it has two flat sides oppositely located to each other. However, in view of the possibility of application to a planar light source or total reflection efficiency, it is preferable to form the optical element into a film-like, sheet-like or plate-like shape having a rectangular cross section as shown in FIG. 3. Particularly, the optical element 10 having a plate like shape is advantageous for ease of handling. The term “plate-like” in the invention is a concept including all these film-like, sheet-like and plate-like shapes.

The optical element 10 has a thickness of preferably 20 μm to 3 mm, more preferably 30 μm to 1 mm, further preferably 40 μm to 500 μm, and particularly preferably 50 μm to 200 μm. When the thickness of the optical element is less than 20 μm, there is a possibility of occurrence of uneven luminance because excitation light emitted from the excitation light source may directly pass through or scattering ability at the minute regions 2 may be impaired. Also, since transmission path of the scattered light at the minute regions 2 is not sufficiently secured, there is a possibility that linearly polarized-light having a sufficient degree of polarization is not obtained. On the other hand, when the thickness of the optical element 10 is more than 3 mm, excitation light is not sufficiently transmitted in a thickness direction of the optical element 10 and all the luminous bodies dispersed cannot be effectively used, so that there is a possibility of decreasing emission efficiency. Therefore, the above thickness is preferred.

Opposite sides 101, 102 (FIG. 3A) of the optical element 10 each preferably has a surface smoothness similar to a mirror surface in view of a light confining efficiency that contributes to the ability to confine light which is formed by the luminous body 3, within the optical element 10 by total reflection. When the opposite sides 101, 102 of the optical element 10 have poor surface smoothness, a translucent film or sheet having excellent surface smoothness may be bonded to the translucent resin 1 with a transparent adhesive or a pressure-sensitive adhesive so as to make the smooth surface of the bonded film or sheet act as a total reflection interface, thereby the same effect as above is also obtained.

Preferably, the luminous body 3 is homogeneously dispersed into either or both of the translucent resin 1 and the minute regions 2. As mentioned above, when light scattering by the luminous body 3 occurs, there is a possibility of depolarization, so that the particle size of the luminous body 3 according to this embodiment is smaller than the emission wavelength thereof. In order to further reduce a possibility of depolarization, the particle size of the above luminous body 3 is preferably not more than one fifth, more preferably not more than one tenth, and further preferably not more than one fiftieth of the emission wavelength of the luminous body.

By controlling the particle size of the luminous body 3 to a size at which a quantum effect occurs (specifically about 1 to 10 nm), luminous bodies 3 having different emission wavelengths depending on the particle sizes can be prepared even when the luminous bodes have the same composition. Therefore, when the luminous bodies 3 having different emission wavelengths depending on the particle sizes are used (luminous bodies having different particle sizes are suitably combined), a broad emission wavelength band can be obtained by suitably controlling the particle size distribution of luminous bodies 3 having the same composition without using plurality of luminous bodies 3 having different compositions. The particle size of the luminous body 3 can be measured using a dynamic light scattering particle size distribution-measuring apparatus manufactured by Otsuka Electronics Co., Ltd. or Horiba Ltd. or a laser zeta-potential electrometer and also can be measured by direct observation on an electron microscope or by flying time measurement proposed by Tsukuba Nano-technology. Also, in a case where a large mass of raw material of the luminous body 3 is pulverized to obtain the luminous body 3, it is possible to obtain a luminous body 3 having a desired particle size by controlling pulverizing conditions (time, rotation sate, pressure, temperature, etc.) or classification through filtration or precipitation after pulverization. Moreover, in a case where the luminous body 3 is obtained by growing atoms and molecules, a luminous body 3 having a desired particle size can be obtained by controlling growth conditions (concentration of dispersion liquid, temperature, feeding rate of raw materials, etc.). Furthermore, in a case where a luminous body 3 is obtained by spattering with electron beam in a rare gas using a raw material of the luminous body 3 as a target, it is possible to obtain a luminous body 3 having a desired particle size by controlling power of the electron beam, kind and concentration of the rare gas, nature of the target, and the like.

Moreover, in a case where an aggregate is formed through aggregation of dispersed luminous body 3, the aggregate shows a behavior similar to the luminous body having a particle size equal to the diameter of the aggregate. Therefore, the diameter of aggregate formed by aggregating the luminous body 3 is preferably smaller than the emission wavelength of the luminous body 3. The diameter of the aggregate formed by aggregating the above luminous body 3 is more preferably not more than one fifth, and ether preferably not more than one tenth of the emission wavelength of the luminous body 3. The diameter of the above aggregate can be measured by the methods similar to the above methods for measuring the particle size of the luminous body 3 itself. Moreover, it is possible to suppress the aggregation of the luminous body 3 by attaching a coupling agent or a surfactant to the surface of the luminous body 3 to electrostatically charge the surface of the luminous body 3.

As the luminous body 3, one or more of suitable materials, which absorb ultraviolet light or visible light and emit light having a wavelength in visible light region upon excitation, can be used. In the invention, the luminous body is preferably an inorganic pigment. An inorganic pigment exhibits a high luminance of emitted light and also has an extremely high durability, so that it can be durable to long-term use. Therefore, it is possible to obtain an optical element 10 excellent in luminance of emitted light, durability, and reliability as compared with the case using a dye-based luminous body. More specifically, it is preferred to use a fluorescent pigment composed of an inorganic pigment radiating fluorescence that is light emitted from singlet excited state, a phosphorescent pigment radiating phosphorescence that is light emitted from triplet excited state, or the like.

When more specifically described, as the luminous body 3, suitably used are CdSe, ZnS, Y₂O₅S, LaPO₄, Ca₁₀(PO₄)₆FCl, (SrCaBaMg)₅(PO₄)₃Cl, BaMgAl₁₀O₁₇, Zn₂SiO₄, (Y,Gd)BO₃, ZnSe, CdSe, ZnTe, CdTe, etc. and also those obtained by doping them with a metal such as Ce, Tb, Eu, Al, Sb, or Mn or a rare-earth element.

The refractive index of an inorganic-pigment is generally 2.0 or more and the pigment is opaque and colored in many cases. For example, CdSe shows coloring of red to orange although it depends on particle size and purity. In a case where such an inorganic pigment is used as the luminous body 3, depolarization of light emitted from excitation by scattering caused by large refractive index difference between the luminous body 3 and a resin for dispersing the same (translucent resin 1 or material forming minute regions 2 and most of them has a refractive index of 1.5 to 1.7) and coloration of light emitted from excitation caused by absorption induced by opacity and coloring of the inorganic pigment itself generally become problems. However, as mentioned above, since the luminous body 3 according to this embodiment has a particle size smaller than the emission wavelength thereof, most of light emitted from excitation directly passes through without being affected by the luminous body 3, so that the above problems hardly occur.

The luminous body 3 can be dispersed in the optical element 10 by a suitable method, such as a method of blending the luminous body 3 prepared beforehand with the translucent resin 1 and a material forming the minute regions 2 together with other additive(s) according to need at the preparation of the optical element 10 or a method of blending raw material of the luminous body 3 beforehand and subsequently precipitating the luminous body 3 by carrying out thermal treatment, optical treatment, oxidative treatment, reductive treatment, acid-base reaction treatment, or the like.

When more specifically described, it is possible to use the methods shown in the following (1) to (4). Namely,

(1) a method of dissolving raw materials of the luminous body 3 with an acid/base or the like, impregnating the solution in a resin (translucent resin 1 or material forming minute regions 2) such as polyvinyl alcohol, and removing the component of the acid/base dissolving the above raw material by treatment after film formation;

(2) a method of dispersing a solution containing a metal ion (e.g., Zn ion) protected by chelation dissolved therein into a resin (translucent resin 1 or material forming minute regions 2), subsequently canceling the chelation, and adding a necessary ion (a sulfide ion obtained from an aqueous Na₂S solution or H₂S gas) to the precipitating metal ion to growth the luminous body 3;

(3) a method of reacting an organometallic compound (e.g., a reaction product of an organic acid such as acetic acid, benzoic acid, formic acid, butyric acid, tartaric acid, lactic acid, or oxalic acid with a metal ion) with an organophosphorus compound (e.g., a phosphate ester), forming a cluster by thermally decomposing the organometallic compound to form the luminous body 3, and dispersing the formed luminous body 3 into a resin (translucent resin 1 or material forming minute regions 2);

(4) a method of adding a surfactant solution to an aqueous solution containing an metal ion dissolved therein to form a cluster and growing the luminous body 3 by refluxing the whole under reductive conditions; or the like method may be suitably employed.

The optical element 10 can be made by various methods such as by producing an oriented film under an appropriate molecular orientation through a stretching treatment of one or more materials having an excellent transparency such as a polymer and/or a liquid crystal in such a combination as to form regions having birefringences different from each other (minute regions). As mentioned above, since the luminous body 3 is dispersed in the optical element 10, it is preferable that at least one of the combined materials can be incorporated into the luminous body 3 to be dispersed, with good compatibility.

As examples of the combination of materials, it can be cited a combination of a polymer and a liquid crystal, a combination of an isotropic polymer and an anisotropic polymer, a combination of anisotropic polymers, etc. In order to achieve even distribution of the minute regions 2, the combination enabling phase separation is preferable. Also, the distribution of the minutes regions 2 can be controlled on the basis of the compatibility of the combined materials. For example, the phase separation can be achieved by various methods such as a method of bringing incompatible materials into solution by a solvent, or a method of heat-melting incompatible materials and mixing them together under molten state.

The mixing ratio of the luminous body 3 is not particularly limited but a necessary quantity of emitted light cannot be obtained when the mixing ratio is too small. Therefore, the mixing ratio of the luminous body 3 is preferably 0.1% by weight or more, more preferably 0.5% or more, and further preferably 1.0% by weight or more. Contrarily, when the mixing ratio of the luminous body 3 is too large, stretching and phase separation of an orientation base material (translucent resin 1 or material forming minute regions 2) may be influenced, so that the mixing ratio may be suitably determined within the range resulting in no such influence. An upper limit of the mixing ratio is preferably 10% by weight or less, and more preferably 5% by weight or less.

In a case where the molecular orientation is made by subjecting the above combination of materials to the stretching treatment, the optical element 10 suitable for each application or purpose can be formed by appropriately setting a stretching temperature and stretching ratio for the combination of a polymer and a liquid crystal and a combination of an isotropic polymer and an anisotropic polymer, or by appropriately controlling the stretching conditions for the combination of anisotropic polymers. While anisotropic polymers are classified into positive and negative based on a characteristics of refractive index variation by the stretching direction, any one of positive and negative anisotropic polymers can be used in this embodiment. Accordingly, the combination of positive anisotropic polymers, the combination of negative polymers, and the combination of positive and negative polymers are all possible to use.

As examples of the above polymers, there may be mentioned ester polymers such as polyethylene terephthalate and polyethylene naphthalate, styrene polymers such as polystyrene and acrylonitrile-styrene copolymer (AS polymers), olefin polymers such as polyethylene, polypropylene, cyclic polyolefine and polyolefins having a norbornene structure, and ethylene/propylene copolymer, acrylic polymers such as polymethyl methacrylate, cellulose polymers such as cellulose diacetate and cellulose triacetate, and amide polymers such as nylon and aromatic polyamides.

As examples of the above transparent polymer, there may be also mentioned carbonate polymers, polyvinyl chloride polymers, imide polymers, sulfone polymers, polyether sulfone, polyether ether ketone, polyphenylene sulfide, vinyl alcohol polymers, vinylidene chloride polymers, vinyl butyral polymers, acrylate polymers, polyoxymethylene, silicone polymers, urethane polymers, ether polymers, vinyl acetate polymers or their mixtures, and thermosetting- or UV-curing polymers such as phenolic, melamine, acrylic, urethane, acrylic urethane, epoxy or silicone polymers.

On the other hand, as examples of the above liquid crystal, there may be mentioned low-molecular-weight liquid crystals and crosslinkable liquid crystal monomers such as cyanobiphenyl, cyanophenylcyclohexane, cyanophenyl ester, phenyl benzoate ester or phenylpyrimidine liquid crystals or their mixtures, which exhibit a nematic phase or smectic phase at room temperature or high temperature, as well as liquid crystal polymers, which exhibit a nematic phase or smectic phase at room temperature or high temperature. The above crosslinkable liquid crystal monomers are usually subjected to a molecular orientation treatment, and then crosslinked into polymers by an appropriate method including the application of heat, light, or the like.

In order to produce the optical element 10 having an excellent heat resistance and durability, it is preferable to use the combination of a polymer having a glass transition temperature of preferably 50° C. or higher, more preferably 80° C. or higher and particularly preferably 120° C. or higher and a crosslinkable liquid crystal monomer or a liquid crystal polymer. An upper limit of the glass transition temperature of the above polymers is preferably 300° C. or lower, more preferably 250° C. or lower, and further preferably 200° C. or lower. As the above liquid crystal polymer, a main-chain type or side-chain type polymer or the like is appropriately used without particular limitation in type. It is preferable to use a liquid crystal polymer having a polymerization degree of preferably 8 or higher, more preferably 10 or higher, and particularly preferably 15 to 5000 in view of contribution to the formation of the minute regions 2 with an excellent homogeneous particle size distribution, as well as thermal stability, film formability easiness of molecular orientation, and the like.

The optical element 10 using a liquid crystal polymer can be formed by various methods such as a method of mixing one or more of polymers with one or more of liquid crystal polymers for forming the minute regions 2, thereby forming a polymer film containing the liquid polymer dispersedly distributed to occupy the minute regions, and subjecting the polymer film to molecular orientation by a suitable method, and thereby forming regions having different birefringences.

Herein, with respect to the refractive index difference between the minute regions 2 and the translucent resin 1, the refractive index difference in an axial direction of the minute regions 2, along which a maximum refractive index difference occurs, is represented by Δn1, and the refractive index differences in directions respectively orthogonal to the axial direction along which the maximum refractive index difference occurs are respectively represented by Δn2 and Δn3. In view of controllability of the refractive index differences by the above molecular orientation, the above liquid crystal polymer has preferably a glass transition temperature of 50° C. or higher and exhibits a nematic phase in a temperature range lower than the glass transition temperature of the polymer (translucent resin 1) simultaneously used. An upper limit of the glass transition temperature of the above liquid crystal polymer is preferably 250° C. or lower, more preferably 200° C. or lower, and further preferably 150° C. or lower. As a specific example thereof, there may be mentioned a side-chain type liquid crystal polymer having a monomer unit represented by the following general formula: General formula:

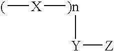

In the above general formula, X represents a backbone group which constitutes the main chain of the liquid crystal polymer, and may be formed by appropriate linking chains such as linear, branched or cyclic groups. As specific examples thereof, there may be mentioned polyacrylates, polymethacrylates, poly(α-haloacrylate)s, poly(α-cyanoacrylate)s, polyacrylamides, polyacrylonitriles, polyphthacrylonitriles, polyamides, polyesters, polyurethanes polyethers, polyimides, and polysiloxanes.

Moreover, Y represents a spacer group branching from the main chain. As examples of the spacer group Y to achieve the formidability of the optical element 10 including control of refractive index difference, there may be preferably mentioned ethylene, propylene, butylenes, pentylene, hexylene, octylene, decylene, undecylene, dodecylene, octadecylene, ethoxyethylene, and methoxybutylene. On the other hand, Z represents a mesogen group which imparts liquid crystal alignment properties.

The above side-chain type liquid crystal polymers to be aligned in nematic orientation may be any appropriate thermoplastic polymers such as homopolymers or copolymers having monomer units represented by the above general formula. Of these, those having an excellent property in monodomain orientation are preferable.

The optical element 10 using a liquid crystal polymer to be aligned in nematic orientation may be formed by, for example, a method that includes: mixing a polymer for forming a polymer film with a liquid crystal polymer that exhibits a nematic phase in a temperature range lower than the glass transition temperature of the polymer and has a glass transition temperature of preferably 50° C. or higher, more preferably 60° C. or higher and particularly preferably 70° C. or higher, thereby forming a polymer film containing the liquid crystal polymer dispersedly distributed so as to occupy the minute regions 2, heating the liquid crystal polymer, which is to form the minute regions 2, to align the same in nematic orientation; and fixing the orientation state by cooling. An upper limit of the glass transition temperature of the above liquid crystal polymer is preferably 250° C. or lower, more preferably 200° C. or lower, and further preferably 150° C. or lower.

A polymer film (translucent resin 1) containing the minute regions 2 dispersedly distributed therein before orientation, that is, a film to be oriented may be formed by an appropriate method such as a casting method, extrusion molding method, injection molding method, roll forming method, flow casting method or the like. It is also possible to form a film by spreading a monomer mixture and polymerizing the spread mixture by heating or irradiation with ultraviolet light or the like.

In view of producing the optical element 10 containing the minute regions 2 excellent in even distribution therein, a film forming method, in which a mixed solution of materials is formed into a film using a solvent by a casting method or a flow casing method, is preferably employed. In such a case, the size and distribution of the minute regions 2 can be controlled by changing the type of the solvent, viscosity of the mixed solution, or drying speed of a layer formed by spreading the mixed solution. The decrease in viscosity of the mixed solution, increase in drying speed of the mixed solution spread layer or the like is effective in reducing the area of the minute regions 2.

While the thickness of the film to be oriented may be appropriately determined, in general, it is preferably set in the range of 10 mm or less, more preferably 30 μm to 5 mm, further preferably 50 μm to 2 mm, and particularly preferably 100 μm to 1 mm in view of easiness of orientation. In forming the film, it is possible to incorporate appropriate additives such as a dispersant, a surfactant, a color tone regulator, a flame retardant, a release agent, and an antioxidant.

The orientation of the film can be made, for example, by employing one or more methods capable of controlling the refractive index by the orientation, such as a uniaxial, biaxial, successive biaxial or Z-axis stretching method; a rolling method; a method of applying an electric field or magnetic field at a temperature higher than the glass transition temperature or liquid crystal transition temperature and sharply cooling to fix the orientation; a method of flow orientation during film forming process; or a method of self-orientation of a liquid crystal on the basis of a slight orientation of an isotropic polymer. Therefore, the optical element 10 produced may be in the form of a stretch film or non-stretched film. For a stretch film, while a fragile polymer may be used, a polymer having an excellent stretchability is preferably used. Moreover, in a case where the thickness of the film to be oriented is 2 mm or more, a suitable orientation can be achieved using a rolling method as the stretching method.

In a case where the minute regions 2 are made of a liquid crystal polymer, the orientation can be achieved, for example, by heating a polymer film to such a temperature as to enable a liquid polymer dispersedly distributed therein to exhibit a target liquid crystal phase such as a nematic liquid phase and turn into a molten state, applying orientation by the action of an orientation regulation force, and then sharply cooling the film, thereby fixing the orientation. The orientation of the minute regions 2 is preferably held in a monodomain state in view of preventing fluctuation in optical characteristics or the like.

As the orientation regulation force, a stretching force available in a process of allowing a polymer film to be stretched by an appropriate ratio, a shearing force in a film forming process, an electric field or a magnetic filed, which are all capable of orienting the liquid crystal polymer, is applicable. One or more of these orientation regulation forces may be applied to achieve an appropriate orientation of the liquid crystal polymer.

A region of the optical element 10 other than the minute regions 2, that is, the translucent resin 1 may possess birefringent or isotropic characteristics. The optical element 10, which exhibits birefringent characteristics in its entire region, can be produced by the molecule orientation in the aforementioned film forming process using a birefringent polymer as a film forming material. According to needs and desires, a known orientation method such as a stretching method is applied so that the birefringent characteristics can be imparted or controlled. The optical element 10, in which a region other than the minute regions 2 has isotropic characteristics, can be produced by a method of stretching a film derived firm an isotropic polymer used as a film forming material in a temperature range lower than the glass transition temperature of the polymer.

As mentioned above, the translucent resin 1 is different in birefringent characteristics from the minute regions 2. Specifically, as mentioned above, with respect to the refractive index difference between the minute regions 2 and the translucent resin 1, when the refractive index difference of the minute regions 2 in an axial direction (a Δn1 direction), along which a maximum refractive index difference occurs, is designated as Δn1, and the refractive index differences in axial directions (Δn2 and Δn3 directions) orthogonal to the axial direction, along which the maximum refractive index difference occurs, are respectively designated as Δn2 and Δn3, it is preferable to have a suitably large Δn1, while preferably keeping Δn2 and Δn3 as small as possible or as close as possible to 0, in view of the total reflection to be mentioned below. The optical element 10 according to this embodiment is controlled so as to preferably have 0.03≦Δn1≦0.5, 0≦Δn2≦0,03, 0≦Δn3≦0.03, and more preferably Δn2=Δn3. These refractive index differences can be controlled by the refractive index of a material used, an orientation method, or the like.

With the refractive index differences Δn1, Δn2 and Δn3 as set above, of the light resulting from excitation by excitation light entering the optical element 10, linearly polarized light in the Δn1 direction is strongly scattered at an angle smaller than an critical angle (a total reflection angle), so that the quantity of light emitted from the optical element 10 to the outside can be increased, while linearly polarized light in directions other than the Δn1 direction is hard to be scattered, thus repeating the total reflection. As a result, the linearly polarized light in directions other than the Δn1 direction can be confined to the inside of the optical element 10.

The refractive index difference between each of the axial directions (Δn1, Δn2 and Δn3) of the minute regions 2 and the translucent resin 1 represents the average refractive index difference between the respective axial directions of the minute regions 2 and the translucent resin 1 in the case of the translucent resin 1 having optically isotropic characteristics. Moreover, in the case of the translucent resin 1 having optically anisotropic characteristics, the above refractive index difference represents the refractive index difference in each axial direction, since the direction of the principal light axis of the translucent resin 1 is usually identical with the direction of the principal light axis of the minute regions 2.

Since the Δn1 direction is parallel to a plane of vibration of linearly polarized light emitted from the optical element 10, the Δn1 direction is preferably parallel to the opposite two sides 101, 102 of the optical element 10. As far as the Δn1 direction is parallel to the two sides 101, 102, the direction may be any direction suitable for a liquid crystal cell or the like to which the optical element 10 is applied.

In view of obtaining a higher homogeneity of the scattering effect or the like in the minute regions 2, it is preferable to have the minute regions 2 dispersedly distributed as evenly as possible in the optical element 10. The size of each minute region 2, particularly the length in the scattering direction, i.e., the Δn1 direction affects backscattering (reflection) or wavelength dependency. In order to improve the light utilization efficiency, prevent coloring due to the wavelength dependency, prevent deterioration in visual recognition due to visualization of the minute regions 2 or deterioration in clear display, or obtain an improved film formability or film strength, the size of each minute region 2, particularly the length in the Δn1 direction is preferably in the range of 0.05 to 500 μm, more preferably 0.1 to 250 μm, and particularly preferably 1 to 100 μm. The minute regions 2 usually exist in the optical element 10 in a domain state and its length in the Δn2 direction or the like is not particularly limited.

While the ratio of the minute regions 2 occupying the inside of the optical element 10 may be appropriately determined in consideration of the scattering characteristics in the Δn1 direction or the like, it is generally set to preferably 0.1 to 70% by weight, more prefrably 0.5 to 50% by weight, and particularly preferably 1 to 30% by weight in view of film strength or the like.

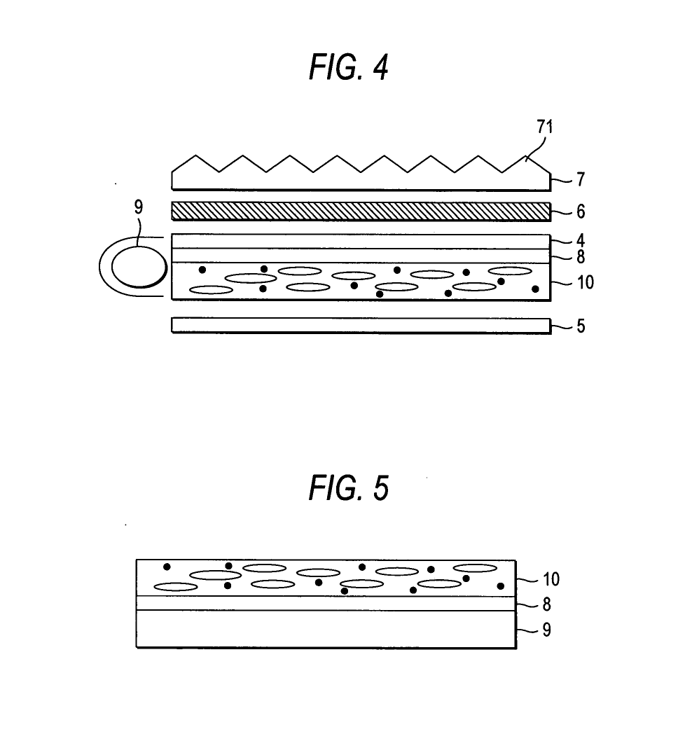

The optical element 10 according to this embodiment can form a polarized-light-emitting planar light source in combination with a light source that emits light having a wavelength capable of exciting the luminous body 3 dipersed in the optical element 10. While the arrangement of the light source and the optical element 10 is not particularly limited, it is desirable to employ an arrangement allowing excitation light to effectively enter the optical element 10. From such a viewpoint, as illustrated in FIG. 4, it is preferable to employ an arrangement with an excitation light source 9 located on a lateral side of the optical element 10, or an arrangement where the excitation light source 9 is a planar light source such as an electroluminescent element and one of the flat sides of the optical element 10 is positioned opposite to an upper side of the planar light source, as illustrated in FIG. 5. The optical element 10 may be independently arranged as illustrated in FIG. 4, or arranged integrally with the excitation light source 9 and/or a translucent support member via a translucent adhesive layer. For producing a more efficient result, a light guiding member for guiding light from the excitation light source into the optical element 10 is preferably provided. The light guiding member is not particularly limited and there may be suitably used those commonly used for back light of liquid crystal displays, such as light guiding plates having a flat plate shape or wedge shape made of a translucent resin and light guiding plates made of the translucent resin containing reflective dots.

The type of the excitation light source 9 is not particularly limited as far as it is an excitation light source, which emits light having a wavelength capable of exciting the luminous body 3. Since the luminous body 3 emits light basically through conversion of a short-wavelength light having a high energy into a long-wavelength light, it is preferable to use an excitation light source emitting ultraviolet light or an excitation light source having an emission band of visible light to ultraviolet light. For example, in a case where an excitation light source emitting visible light is used as the excitation light source 9, when visible light itself, which is excitation light, is transmitted, color reproduction tends to be inhibited. Particularly, in a case of preparing white light, the transmittance of light from the excitation light source should be also considered and hence the setting becomes complex. However, when an excitation light source emitting ultraviolet light is used as the excitation light source 9, even in a case where the ultraviolet light is transmitted, the light is not visible and hence it is not necessary to consider the transmittance of light from the excitation light source in the setting. Moreover, as in the case of white light formation for light-emitting diode (LED), using blue visible light as excitation light and a yellow fluorescent body YAG:Ce=cerium-incorporated yttrinum aluminum garnet) as the luminous body 3, apparent white light may be formed using the emitted light from the yellow fluorescent body and transmitting excitation light but the apparent white light is poor in color reproduction since it lacks red color component. Therefore, in order to obtain true white light, it is preferred to use a luminous body 3, which emits light consisting of three primary colors such as R (red color)/G (green color)/B (blue color), and it is desired to use an excitation light source emitting ultraviolet light of a short-wavelength side having a high energy as mentioned above as the excitation light source 9 emitting light having a wavelength capable of exciting the optical element 3, which emits light consisting of such three primary colors.

When more specifically described, as the excitation light source 9 according to this embodiment, there may be suitably used conventional ultraviolet to visible light-emitting light sources using mercury vapor, such as hot cathode fluorescent tubes and cold cathode fluorescent tubes, and also mercury-free fluorescent tubes using environmentally-friendly substances such as xenon gas, manufactured and sold by Sanyo Electric Co., Ltd. and Samsung Electronics Co., Ltd., for example, and high-luminance LET's having emission band of ultraviolet region to visible region, manufactured and sold by Nichia Corporation, Toyoda Gosei Co., Ltd., Lumileds, Courier, and the like.

Herein, in a direct back light device using a conventional common visible light-emitting light source, a direct image of the light source itself having a high light intensity is viewed, so that evenness of emission is remarkably impaired. Therefore, it is necessary to provide a mask for avoiding such direct viewing of the image or to provide a diffusion material for varying transmittance just above the light source.

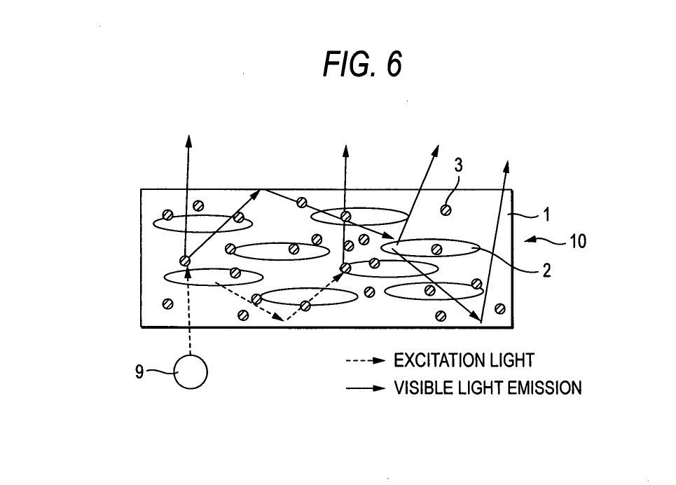

To the contrary, in a case of the polarized-light-emitting planar light source obtained by combining the optical element 10 according to the invention and the excitation light source 9, both of excitation light resulting from the excitation light source 9 and visible light generated by excitation of the luminous body 3 are transmitted within the optical element 10 through scattering by the minute regions 2 and reflection at the front and rear sides of the optical element 10. Therefore, as shown in FIG. 6, even if the excitation light source 9 is supposedly a point light source, the transmitted excitation light collides with the luminous body 3 anywhere to excite the luminous body 3, thereby visible light being generated. On the other hand, as mentioned above, when an excitation light source emitting ultraviolet light or an excitation light source 9 having an emission band of ultraviolet light to visible light is used, excitation light itself is not clearly viewed by eyes, so that the vicinity of the excitation light source 9 is not specifically viewed brightly. Therefore, evenness of emission on visual light resulting from the polarized-light-emitting planar light source is relatively good as far as the luminous body 3 is homogeneously dispersed.

Moreover, when a material absorbing relatively much light having the wavelength of excitation light is used as the translucent resin or the minute regions, the material absorbs the excitation light and hence emission efficiency tends to be lowered. Furthermore, when ultraviolet light is used as the excitation light, deterioration of the material may be invited owing to the absorption of ultraviolet light. Thus, the use of a material substantially absorbing no light having the wavelength of excitation light as a material of the translucent resin or the minute regions can reduce decrease in emission efficiency and deterioration of the material as far as possible. Furthermore, in a case where the excitation light source 9 is an excitation light source emitting ultraviolet light, both of the translucent resin 1 and the minute regions 2 are both preferably made of materials that do not substantially absorb ultraviolet light.

In a case where a material substantially absorbing no light having the wavelength of excitation light is used is the material of the translucent resin 1, any of inorganic materials, organic materials, and mixtures thereof may be employed as such a material as far as it is a material substantially absorbing no light having the wavelength of excitation light. Thus, it is possible to select optional one according to the emission wavelength of the excitation light source 9. Particularly, in a case where ultraviolet light is used as excitation light, cyclic polyolefins or polyolefins having a norbornene structure, and the like may be mentioned, for example. Moreover, in a case where a material substantially absorbing no light having the wavelength of excitation light is used as the material of the minute regions 2, any of inorganic materials, organic materials, and mixtures thereof, which substantially absorb no light having the wavelength of excitation light, may be employed as such a material as far as it satisfies the relation of refractive index with the translucent resin 1. Particularly, when an excitation light source emitting ultraviolet light is used as the excitation light source 9, it is preferred to use crystals of an inorganic compound having an anisotropic crystal structure, such as strontium carbonate, lithium niobium trioxide, calcium carbonate, calcium sulfate dehydrate, potassium phosphate, or silicon dioxide.

The optical element 10 according to this embodiment may be formed with a single layer, or two ore more layers bonded together. The optical element made through such a multilayer structure or superimposition can exhibit a scattering effect which is synergized or enhanced to such a degree higher than an effect resulting from only increase in thickness. The layers are preferably superimposed to each other in such a manner as to have the Δn1 directions parallel to each other. The number of layers superimposed is two or more that may be suitably determined.

The optical element 10 to be superimposed may have Δn1, Δn2 and Δn3 identical or different in each layer. Also, the luminous body 3 contained in each optical element 10 may be made of the same or different materials. The layers are preferably superimposed to each other in such a manner as to have a parallel relationship in the Δn1 direction, while misalignment of the layers due to operational errors or the like is acceptable to some extent. When the fluctuation of the Δn1 direction or the like occurs between the layers, these layers are preferably set with their average directions to have a parallel relationship with each other.

A layered structure of the optical element 10 in combination with an excitation light source, a support member, a light guiding plate or the like, or a layered structure of plural optical elements 10 is made by bonding them together via an adhesive layer or the like so as to make a total reflection interface serve as an outermost surface of a layered structure. As an adhesive layer, a hot melt adhesive, pressure sensitive adhesive or any other suitable type adhesive may be used. In view of suppressing reflection loss, an adhesive layer having a small refractive index difference with respect to the optical element 10 is preferably used. The bonding may be also made by the use of a resin for forming the light passing resin 1 or the minutes regions 2. As the above adhesive, for example, an appropriate adhesive including a transparent adhesive such as acrylic, silicone, polyester, polyurethane, polyether or rubber adhesive can be used without particular limitation, while it is preferable to use an adhesive that does not require application of high temperature for curing or drying, or does not require a long time for curing or drying, in view of prevention of changes in optical characteristics or the like. Also, a resin that is unlikely to cause a so-called delamination phenomenon such as layer-lifting or layer-peeling under heating or humidification conditions is preferable.

Therefore, as the adhesive, it is preferable to use an acrylic pressure sensitive adhesive containing an acrylic polymer as the base polymer having a weight-average molecular weight of 100,000 or more, resulting from copolymerization of an alkyl ester of (meth)acrylic acid having an alkyl group having 20 or less carbon atoms, such as a methyl group, an ethyl group or a butyl group, with an acrylic monomer comprising a modifying component such as (meth)acrylic acid of hydroxyethyl(meth)acrylate, in such a combination as to have a glass transition temperature of 0° C. or lower. The acrylic pressure sensitive adhesive has an advantage in transparency, weather resistance, heat resistance and the like.

The adhesive layer may be attached to the optical element 10 by any method appropriate to each case. Specifically, there may be mentioned a method of melting or dispersing adhesive ingredients into a solvent made of any one of toluene, ethyl acetate and the like or mixture thereof to prepare an adhesive solution of about 10 to 40% by weight and directly applying the adhesive solution on the optical element 10 by a suitable spreading method such as a flow-casting or coating method, or a method of forming an adhesive layer on a separator following the above steps and transferring the adhesive layer onto the optical element 10. The adhesive layer to be attached can be formed in layered structure having different compositions or types.

The thickness of the adhesive layer is appropriately set according to adhesive power or the like, while it is generally set in the range of 1 to 500 μm. It is also possible to appropriately mix an additive such as a natural resin, a synthetic resin, glass fibers, glass beads, a filler made of metal powder or other inorganic powder, a pigment, a color agent, or an antioxidant in the adhesive layer according to needs and circumstances.

In the example illustrated in FIG. 4, a translucent sheet 4 having an excellent smoothness is bonded on the optical element 10 via an adhesive layer 8 as described above, in which a smooth surface (an upper side) of the translucent sheet 4 bonded serves as a total reflecting interface.

The optical element 10 is preferably structured so as to entirely or partially have a phase difference in view of the necessity to appropriately eliminate a polarized state during light transmits through the optical element 10. Basically, the slow axis (the axis in the Δn1 direction) of the optical element 10 has an orthogonal relationship with the polarization axis (plane of vibration) of the linearly polarized light, along which light is hard to be scattered, and therefore polarization conversion due to phase Clarence is hard to occur. However, it is assumed that slight scattering causes changes in apparent angle and hence causes polarization conversion.

From the point of view of causing the polarization conversion, the optical element 10 preferably has a phase difference between in-plane directions of 5 nm or greater in general, while this phase difference may be varied according to the thickness of the optical element 10. A preferable upper limit of the phase difference between in-plane directions of the optical element is not categorically determined. This phase difference can be given by employing an appropriate method, such as a method of incorporating birefringent fine particles in the optical element 10 or a method of attaching the same on the optical element 10, a method of giving the birefringent characteristics to the translucent resin 1, a method of employing these methods in combination, or a method of forming birefringent films into an integral laminate structure.

In order to allow the optical element 10 to efficiently emit polarized light through one of the front and rear sides thereof in the polarized-light-emitting planar light source, to which the optical element 10 according to this embodiment is applied, a reflection layer 5 is preferably located as illustrated in FIG. 5. In the example as illustrated in FIG. 5, the reflection layer 5 is located on the rear aide (lower side) of the optical element 10, so that light emitted through the rear side of the optical element 10 is reversed via the reflection layer 5 without change in a polarized state and the thus emitted light is concentrated on the spice of the optical element 10. Whereby, the luminance of the optical element 10 can be enhanced.

The reflection layer 5 preferably has a mirror surface in order to sustain the polarized state. For this purpose, it is preferable to form the reflection layer 5 having a reflection surface made of a metal or dielectric multilayer film. As the metal, aluminum, silver, chrome, gold, copper, in, zinc, indium, palladium or platinum, or their alloy can be appropriately used.

The reflection layer 5 may be directly brought into tight contact with the optical element 10 as an attached layer of a metal thin film by vapor deposition, but is hard to produce perfect reflection and hence causes slight absorption by the reflection layer 5. Accordingly, in view of the fact that the total reflection of the light transmitting in the optical element 10 is repeated, the direct tight contact of the reflection layer 5 to the optical element 10 may cause absorption lose. In order to prevent this absorption loss, it is preferable to only overlay the reflection layer 5 on the optical element 10 (i.e., allowing air to be interposed between).

Accordingly, as the reflection layer 5, it is preferable to use a reflection plate having a substrate with a metal thin film attached thereon by sputtering or vapor deposition, or a plate-like member such as metal foil or rolled metal sheet. As the substrate, it is possible to appropriately use a glass plate, resin sheet or the like. Particularly, the reflection layer 5 is preferably formed by vapor deposition of silver, aluminum or the like on a resin sheet in view of reflectivity, hue, handling property or the like.

On the other hand, as the reflection layer 5 made of a dielectric multilayer film, a film disclosed in JP-T-10-511322 or the like can be appropriately used.

In addition to the arrangement of locating the reflection layer 5 on the rear side of the optical element 10 as illustrated in FIG. 4, it is possible to locate the reflection layer 5 anywhere, for example, on the front side or lateral side of the optical element 10, or in a case of the arrangement with a light guide plate, on the front, rear or lateral side thereon or any other place appropriate to each case.

As illustrated in FIG. 4, in the polarized-light-emitting planar light source to which the optical element 10 according to this embodiment is applied, a polarization-maintaining lens sheet 7, a light diffusion layer 6 or the like may be located on a light-retrieving side (upper side) of the optical element 10. Also, it is possible to appropriately locate a wavelength cut filter (not shown) or a retardation film (not shown).

The lens sheet 7 is provided so as to control optical path of the light (linearly polarized light) emitted from the optical element 10, while maintaining its polarization, so as to improve the directivity toward the front side, which is advantageous in visual recognition characteristics, and so as to allow the emitted light having scattering characteristics to have an intensity peak on the front side.

As the lens sheet 7, an appropriate type of lens sheet may be used without particular limitation, which is capable of controlling the optical path of the scattered light entered through one of the opposite sides (rear side) of the optical element 10 and efficiently emitting the lift through the other side (front side) in a direction orthogonal to the sheet surface (in the front direction). Therefore, except for the polarization-maintaining characteristics, it is possible to use any lens sheet having a varying lens form, as disclosed in JP-A-5-169015, which is used in a conventional, so-called sidelight-type light guide plate.

As the lens sheet 7, it is preferable to use a lens sheet having an excellent transmittivity, for example, with a total transmittance of the light being preferably 80% or higher, more preferably 85% or higher and particularly preferably 90% or higher, and with a transmittance of the light leaked as a result of eliminating the polarization being preferably 5% or lower, more preferably 2% or lower and particularly preferably 1% or lower in a case where the lens is set in a cross-Nicol position, as well as enabling emission of light still possessing the polarization characteristics.

In general, the elimination of the polarization is caused by birefringence, multiple scattering or the like, and therefore the lens sheet 7 exhibiting the polarization-maintaining characteristics can be achieved by reducing the birefringence, or reducing an average number of reflections (scatterings) of light transmitting in the lens. Specifically, it is possible to prepare the lens sheet 7 with the polarization-maintaining characteristics by the use of one or more of resins having small birefringence characteristics (resins having an excellent optically isotropic characteristics), such as cellulose triacetate resin, polymethyl methacrylate, polycarbonate, norbornene resin or the like, which are exemplified in the above as a polymer used for the optical element 10.

The lens sheet 7 may be of various lens forms such as a lens form with a large number of lens regions (particularly minute lens regions) of a convex lens type or a refractive index distribution type (GI type), made of a transparent resin substrate, which may contain a resin having a different refractive index, and photopolymer placed on or inside of the resin substrate so that a refractive index is controlled through the photopolymer; a lens form with a lens region made of a transparent resin substrate formed with a large number of through-holes in which a polymer having a different refractive index is filled; or a lens form with a large number of spherical lenses arranged in a single layer and fixed within a thin film. However, in view of the optical path control by setting different refractive indexes, it is preferable to use a lens sheet wherein a lens configuration 71 having an irregular surface structure is provided on the surface of the lens sheet 7.

The irregular surface structure, which forms the lens configuration 71, may be varied, as far as it can control the path of light, which has been transmitted through the lens sheet 7, so as to concentrate the transmitted light towards the front side. For example, there may be mentioned an irregular surface structure having a large number of linear grooves having triangular cross section and protrusions alternately aligned parallel or arranged in lattice pattern, or an irregular surface structure having a large number of minute protrusions each having a bottom of a triangular-pyramid, quadrangular-pyramid, or polygonal-pyramid vertex, which are arranged in dot patterns. The irregular surface structure in a linear or dot pattern may be a spherical lens, aspheric leas, half-round lens or the like.

The lens sheet 7 having an irregular surface structure in a linear or dot pattern can be formed by an appropriate method such as a method of filling a resin solution or resin-forming monomer into a mold having a molding surface conformed to create a predetermined irregular structure, optionally subjecting the filled solution or monomer to polymerization according to needs and circumstances and then transferring the molded irregular structure onto a target surface, or a method of heating a resin sheet and pressing the same into the aforesaid mold to transfer the irregular surface structure onto a target surface. The lens sheet 7 may be of a layered structure with two or more resin layers of the same or different types, such as a lens sheet made of a substrate sheet to which a lens form is applied.

One or more layers of the lens sheet 7 may be located on the light-emitting side of the optical element 10. In a case where two or more layers of the lens sheets 7 are located, they may be of the same type as each other or different types from each other, while it is preferable to exhibit the polarization-maintaining characteristics throughout the entirety thereof. In a case where the lens sheet 7 is located in proximity with the optical element 10, the lens sheet 7 is preferably located with a clearance to the optical element 10, that is, to have an air layer interposed therebetween, in the same manner as in the case of the reflection layer 5. It is preferable that the clearance is sufficiently greater than a wavelength of the incident light.

In a case where the lens for, of the lens sheet 7 has an irregular surface structure in linear pattern, it is preferable to locate the lens sheet 7 so as to allow the linearly aligned members of the irregular surface structure to be oriented parallel or orthogonal to the optical axis direction of the optical element 10 (a direction of the plane of vibration of the emitted polarized light) in order to provide appropriate control of the optical path towards the front side. When two or more layers of the lens sheets 7 are located, it is preferable to locate them to have the aligned directions of the linearly aligned members thereof crossing each other in view of efficient optical path control.

The light diffusion layer 6 serves to, for example, equalize the light emission by scattering light emitted from the optical element 10 while maintaining the polarization thereof, or limit the irregular surface structure of the lens sheet 7 from being visualized so as to improve the visual recognition characteristics and the like.

As the light diffusion layer 6, it is preferable to use one having excellent transmittivity of light and polarization-maintaining characteristics for the emitted light as in the case of the lens sheet 7. Therefore, the light diffusion layer 6 is preferably formed by the use of a resin having small birefringence characteristics such as those exemplified for the lens sheet 7. For example, it is possible to form the light diffusion layer 6 having the polarization-maintaining characteristics by dispersedly distributing transparent particles in the resin, or providing a surface with a resin layer having a minute irregular surface structure.

As transparent particles to be dispersedly distributed in the above resin, there may be mentioned inorganic fine particles made of silica, glass, alumina, titania, zironia, tin oxide, indium oxide, cadmium oxide, antimony oxide or the like that may have electric conductivity, or organic fine particles made of a crosslinked or uncrosslinked polymer such as an acrylic polymer, polyacrylonitrile, a polyester, an epoxy resin, a melamine resin, a urethane resin, polycarbonate, polystyrene or a silicone resin, benzoguanamine, melamine, benzoguanamine condensate, or benzoguanamine-formaldehyde condensate.

One or more materials are used to make the transparent particles, and the particle size is preferably 1 to 20 μm in diameter in view of light diffusing capability, equal diffusion characteristics or the like. While the particle shape is optionally determined, a (true) spherical shape, its secondary aggregate or the like is generally used. Particularly, it is preferable to use transparent particles having a refractive index ratio of 0.9 to 1.1 to the resin in view of the polarization-maintaining characteristics.

The light diffusion layer 6, which contains the aforementioned transparent particles, can be formed by an appropriate known method, such as a method of incorporating transparent particles into a molten resin solution and extruding it into a sheet or the like, a method of blending transparent particles into a resin solution or monomer and then casting the solution into a sheet or the like, and optionally subjecting it to polymerization according to needs and circumstances, or a method of applying a resin solution containing transparent particles on a predetermined surface or a substrate film having the polarization-maintaining characteristics.

On the other hand, the light diffusion layer 6 having minute irregular surface structures can be formed by an appropriate method, for example, a method of roughening the surface of a sheet made of a resin by buffing such as sandblasting or embossing finish, or a method of forming a layer of a translucent material on the surface of the resin sheet so as to provide protrusions thereon. However, it is not preferable to employ a method of forming protrusions having a large refractive index difference to the resin, such as air bubbles or titanium oxide fine particles because a minute irregular surface structure formed by this method tends to eliminate the polarization.

The minute irregular surface of the light diffusion layer 6 preferably has a surface roughness higher than the wavelength of the incident light but not higher than 100 μm in view of light diffusing characteristics, its equal diffusion characteristics or the like, and preferably have an irregular pattern with no periodicity.

For forming the light diffusion layer 6 of the above types that contains transparent particles or has a minute irregular surface, it is preferable to limit increase in phase difference due to photoelasticity or orientation, particularly in a base layer made of the aforementioned resin in view of the polarization-maintaining characteristics.

The light diffusion layer 6 may be arranged in the form of an independent layer having such as a plate-like shape, or a dependent layer internally formed with the lens sheet 7 in tight contact with each other. When the light diffusion layer 6 is located adjacent to the optical element 10, it is preferable to locate them to have a clearance therebetween in the same manner as in the case of the lens sheet 7. When two or more layers of the light diffusion layers 6 are provided, they may be of the same type as each other or different types from each other, while it is preferable for them to exhibit the polarization-maintaining characteristics throughout the entirety thereof.

The wavelength cut filter as mentioned above is used for the purpose of preventing direct light from the excitation light source 9 from entering a liquid crystal display element or the like, which is illuminated by the polarized-light emitting-planar light soured according to this embodiment. Particularly, in a case where excitation light is ultraviolet light, a wavelength cut filter is preferably used in order to prevent deterioration of liquid crystal, polarizing plate or the like due ultraviolet light. The wavelength cut filter may also be used for the purpose of eliminating visible light rays of unnecessary wavelength.

As the wavelength cut filter, there may be mentioned a film that is made by dispersing a material, which absorbs a target wavelength (e.g., an UV absorber such as an salicylate ester compound, a benzophenol compound, a benzotriazole compound, a cyanoacrylate compound, or a nickel complex salt compound), in a resin capable of allowing visible light to pass therethrough or applying the material on the resin, a film made of a translucent film with a cholesteric liquid crystal layer formed thereon, a film that reflects light of a target wavelength through the reflection of a dielectric multilayer film, or the like. It is also possible to incorporate an UV absorber or the like in the optical element 10 or any other optical member, enabling the optical element 10 or any other optical member itself to serve to cut wavelength.

The retardation film as mentioned above is used for the purpose of converting linearly polarized light emitted from the optical element 10 into light in a given polarized state. For example, it is possible to convert linearly polarized light into circular polarized light by the a engagement that a quarter-wave plate as a retardation film is located to have a slow axis oriented 45° to the linearly polarized light emitted, or rotate the polarization axis of the linearly polarized light emitted from the optical element 10 by using a half wave plate.

As the retardation film, there may be mentioned a film comprising a polymer film, which is generally used for compensating liquid crystal cells, a film comprising a translucent film having an oriented liquid crystal polymer or the like attached thereon, or the like.

Each of the lens sheet 7, the light diffusion layer 6, the wavelength cut filter and the like described in the above may be used as a separate layer, or some or an of them may make up a single film in laminate structure. Also, they can be tightly bonded via an adhesive layer or the like to a liquid crystal display element to be located thereon. However, for the lens sheet 7 having an irregular surface structure or the light diffusion layer 6 having a minute irregular surface structure mentioned above, it is preferable to locate them with a distance to the liquid crystal display element.

It is also preferable to locate each of the lens sheet 7, the light diffusion layer 6, the wavelength cut filter and the like with a distance to the optical element 10 so as to prevent the control of the condition of the critical angle within the optical element 10 in view of retrieving polarized light in an efficient manner.

The optical element 10 according to this embodiment and the polarized-light-emitting planar light source, to which the optical element 10 is applied, is capable of allowing light, which results from excitation by incident light from the excitation light source 9, to be emitted from the optical element 10 in the form of linearly polarized light, and also capable of controlling the polarization direction (the plane of vibration). Therefore, they are suitably applicable in various devices or to various fields, such as a liquid crystal display that utilizes linearly polarized light.

### EXAMPLES

Examples and comparative examples will be provided in order to further distinguish the features of the present invention. The following will describe modes for carrying out the invention in detail with reference to Examples but the invention is not limited to these Examples.

### Example 1

(1) Material for Preparing Optical Element

POVAL PVA 124 (degree of polymerization: 2400), a polyvinyl alcohol manufactured by Kuraray Co., Ltd., a liquid crystal monomer UCL008 manufactured by Dainippon Ink and Chemicals, Incorporated, and a dispersion liquid (corresponding to 20% by weight) of ZnS nanoparticles (particle size: 2 to 4 nm,) manufactured by Sumitomo Osaka Cement Co., Ltd. were used as a translucent resin, a material for preparing minute regions, and a luminous body, respectively. Furthermore, a fluorine-based leveling agent, Megafac manufactured by Danippon Ink and Chemicals, Incorporated was used as a leveling agent.

(2) Preparation of Polyvinyl Alcohol Solution

The above polyvinyl alcohol was dissolved in hot water to prepare a 13% aqueous solution. To such an aqueous polyvinyl alcohol solution (aqueous PVA solution) was added glycerin in an amount corresponding to 15% by weight based on the solid matter. On the other hand, 2.9 g of the above liquid crystal monomer, 0.014 g of the above leveling agent, and 2.9 g of the above luminous body (solid matter) were mixed with each other and the whole was heated and stirred until an isotropic phase was formed. Then, after they became homogeneous, 450 g of the above aqueous PVA solution heated at 90° C. was added thereto and mixed. The mixing was conducted at 6000 rpm for 20 minutes using a homomixer. The resulting mixture was allowed to stand for 24 hours in a warm state kept at 35° C. to obtain a bubble-free homogeneous polyvinyl alcohol solution.

(3) Film Formation

The above polyvinyl alcohol solution was applied in a wet thickness of 1 mm by means of an applicator and subjected to drying conditions of 110° C.×20 minutes and annealing conditions of 140° C.×4 minutes to obtain a dried base material.

(4) Stretching

The above base material was stretched to 400% extension in an aqueous boric acid solution (4% by weight, 60° C.), thereby an optical element being prepared.

With regard to the above optical element, refractive index difference Δn1 was 0.15 and each of Δn2 and Δn3 was 0.01. At the measurement of the refractive indices, refractive index was measured by means of an Abbe refractometer on an optical element wherein polyvinyl alcohol was solely subjected to stretching under the same conditions as above or an optical element wherein the above liquid crystal monomer was applied on an orientation film, then oriented and fixed. Then, differences therebetween were calculated as Δn1, Δn2, and Δn3. The luminous body was present mainly in polyvinyl alcohol in a dispersed state. Moreover, when average length of the minute region (liquid crystal monomer) was measured by coloration based on retardation by polarized microscopic observation, length in a long-axis direction was about 5 μm and length in a short-axis direction was about 1.5 μm.

### Example 2

An optical element was prepared in accordance with Example 1 except that the polyvinyl alcohol solution was applied in a wet thickness of 2 mm and the dried base material was stretched to 500% extension.

### Example 3

A film was formed by casting using a 25% by weight toluene solution containing 94 parts (parts by weight, the same shall apply hereinafter) of a norbornene resin (ARTON manufactured by JSR Corporation, glass transition temperature: 182° C.), 5 parts of strontium carbonate as a material of preparing minute regions, and 1 part of ZnS nanoparticles (manufactured by Sumitomo Osaka Cement Co., Ltd., excitation wavelength: 345 nm, emission wavelength: 580 nm) dissolved therein. Then, the film was heated from 50° C. to 120° C. at a constant gradient and dried for 1 to 2 hours. Thereafter, the film was stretched at 170° C. to 200%, extension to prepare an optical element having a thickness of 80 μm.

### Example 4

An optical element was prepared in accordance with Example 3 except that silicon dioxide was used instead of strontium carbonate.

In this connection, Table 1 shows light absorption wavelengths of individual materials used for preparation of the optical elements according Examples 3 and 4. In Table 1, numerals described in the columns of the translucent resin and the minute regions mean light absorption wavelength bands. Moreover, numerals described in the column of the luminous body mean excitation wavelengths. Furthermore, numerals described in the column of the excitation light source mean central wavelengths of emitted light.

TABLE 1

| | | | | Excitation light |
|---|---|---|---|---|
| | Translucent resin | Minute regions | Luminous body | source |
| Example 3 | Norbornene resin | Strontium carbonate | ZnS nanoparticles | Ultraviolet LED |
| | less than 300 (nm) | less than 300 (nm) | 345 nm | 365 nm |
| Example 4 | Norbornene resin | Silicone oxide | ZnS nanoparticles | Ultraviolet LED |
| | less than 300 (nm) | less than 200 (nm) | 345 nm | 365 nm |
| Referential | Norbornene resin | Liquid crystal polymer | ZnS nanoparticles | Ultraviolet LED |
| Example | less than 300 (nm) | less than 450 nm | 345 nm | 365 nm |

### Reference Example

An optical element was prepared in accordance with Example 3 except that a material that absorbed relatively much light of excitation light wavelength (specifically, the liquid crystal polymer represented by the following chemical formula glass transition temperature of 70° C., nematic liquid crystallization temperature of 190° C.) was used as a material for preparing minute regions instead of strontium carbonate used in Example 3. In this connection, Table 1 shows light absorption wavelengths of individual materials used for preparing the optical element according to the present Reference Example.

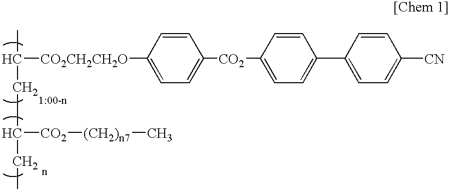

### Comparative Example 1

An optical element was prepared in accordance with Example 1 except that there was used, as a luminous body, one wherein ZnS manufactured by Wako Pure Chemical Industries, Ltd. was pulverized in a homogenizer to form particles having an average particle size of 1 μm and a maximum particle size of 10 μm.

### Comparative Example 2

A film having a thickness of 100 μm was prepared by casting using a 20% by weight dichloromethane solution containing 950 parts (parts by weight the same shall apply hereinafter) of a norbornene resin (ARION manufactured by JSR Corporation, glass transition temperature: 182° C.), 50 parts of a liquid crystal polymer represented by the following chemical formula (glass transition temperature: 80° C., temperature for nematic liquid crystal: 100° C. to 290° C.) and 2 parts of 3-(2-benzothiazolyl)-1-diethylaminocoumarin (coumarin 540) dissolved therein. The film was stretched at 180° C. to 300% extension and then rapidly cooled, thereby an optical element being prepared.

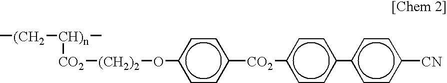

The optical element thus formed was constituted by a transparent film made of a norbornene resin and a liquid crystal polymer dispersed therein as domains of about the same shape elongated in the stretch direction and had a refractive index difference Δn1 of 0.23 and refractive index differences Δn2 and Δn3 of 0.029. At the measurement of the refractive indices, refractive index was measured by means of an Abbe refractometer on an optical element wherein the norbornene resin was solely subjected to stretching under the same conditions as above or an optical element wherein the above liquid crystal monomer was solely applied on an orientation film, then oriented and fixed. The differences between the measured refractive indexes were respectively calculated as Δn1, Δn2 and Δn3. Coumarin was present in a molten state in the norbornene resin. The average particle size of minute regions (domains of the liquid crystal polymer) was measured by coloration through polarizing microscopic observation on the basis of the phase difference. As a result, it has been found that the length in the Δn1 direction was about 5 μm.

After bonding the optical element of the Example 1 to a glass plate (thickness: 3 mm) by using an acrylic adhesive, a silver-deposited mirror-finished reflective sheet, which was prepared by vapor deposition of silver on a polyethylene terephthalate sheet, was located on the side opposite to side on which the glass plate was bonded, to prepare a multilayer member, and a black-light cold cathode fluorescent lamp was fixed on any one of the opposite sides of the multilayer member by a lamp reflector of a mirror-finished reflective sheet. Thus, a polarized-light-emitting planar light source was formed.

### Evaluation

With regard to the optical elements of Examples 1 and 2 and Comparative Example 2, breakage did not occur and defective appearance was not observed during the preparation. To the contrary, with regard to the optical element of Comparative Example 1, there was observed defective appearance that large particles of the luminous body protruded from the surface and fine concavity and convexity are formed at film formation. Furthermore, cracks were formed start from large particles of the luminous body and then the film was broken at stretching.

Using a point light source, an ultraviolet emission LED (NSHU 590A) manufactured by Nichia Corporation as an excitation light source for allowing excitation light to enter the optical elements of Examples 1 and 2 and Comparative Example 1, ultraviolet light was emitted at 15 mA and allowed to enter each optical element. On the optical elements of Examples 1 and 2, the output intensities of the respective components of linearly polarized light in the Δn1 direction and the Δn2 direction of emitted light were measured using a commercially available polarizer (a 99.99 degree of polarization). As a result, it was found that a linearly polarized light was emitted uniformly almost all over the surface of the optical element in a ratio of 4:1 in the optical element of the Example 1 and 6:1 in the optical element of the Example 2. To the contrary, on the optical element of Comparative Example 1, strong light scattering was observed at the luminous body and hence a linearly polarized light in a ratio of about 1.5:1 was only obtained.

On the other band, green luminescence having a center wavelength of 505 nm was observed upon irradiation of the optical element of the optical element of Comparative Example 2 with light emitted from a backlight fluorescent lamp (center wavelength of 360 nm) as excitation light. The output intensities of the respective components of linearly polarized light in the Δn1 direction and the Δn2 direction of emitted light were measured by using a commercially available polarizer (a 99.99 degree of polarization). Then, it was found that a linearly polarize light was emitted in a ratio of 6:1.

Also, it was found that, in the polarized-light-emitting planar light source of Comparative Example 2, linearly polarized light of the optical element in the Δn1 direction was emitted in plane. However, with regard to the polarized-light-emitting planar light source of Comparative Example 2, coumarin was deteriorated in thermal reliability test after the treatment of 90°×24 hours and luminance of emitted light was remarkably lowered.

In addition, on the optical elements of Examples 3 and 5, color reproduction by eyes as well as material deterioration and emission efficiency by ultraviolet light absorption were evaluated.

(1) Color Reproduction (Visual Recognition Characteristics)

When the optical elements obtained in Examples 3 and 4 were irradiated with light from ultraviolet LED having a sharp peak having a center wavelength of 365 nm as excitation light, red light having a peak wavelength of 580 nm was observed but the other colors were not visually observed. On the other hand, purplish color mixed in red light was visually observed upon irradiation with light emitted from a black lamp (center wavelength of 370 nm) having a gentle-slope peak containing wavelengths in a visible band of 350 nm to 400 nm as excitation light. This may be because part of visible light of 400 nm or shorter contained in light from the black lamp as the excitation light source is transmitted through the optical element and is visually observed. Therefore, it was found that it is preferred to use an excitation light source emitting ultraviolet light containing no waveless within a visible band.

(2) Emission Efficiency

When light emission of the optical elements according to Examples 3 and 4 and Reference Example was investigated using the above ultraviolet LED, it was confirmed that the optical elements according to Examples 3 and 4 exhibited emission efficiency about 40% higher than that of the optical element according to Refereuce Example.

(3) Material Deterioration by Ultraviolet Absorption

After the optical elements according to Examples 3 and 4 and Reference Examples were subjected to an irradiation test with ultraviolet light (irradiation with ultraviolet light having a radiation intensity of 500 W/m² for 3 days), the output intensities of the respective components of linearly polarized light in the Δn1 direction and the Δn2 direction of emitted light were measured using an ultraviolet LED as an excitation light source. As a result, linearly polarized light was emitted in a ratio of 5:1 in the optical elements of the Examples 3 and 4 but in a ratio of about 1:1 in the optical element of Reference Example. This may be because the liquid crystal as minute regions is deteriorated by the irradiation test with ultraviolet light and hence the anisotropy of the liquid crystals is lost.

While the present invention has been described in detail and with reference to specific embodiments thereof it, will be apparent to one skilled in the art that various changes and modifications can be made therein without departing from the spirit and scope thereof.

The present application is based on Japanese Patent Application No. No. 2004-88122 filed on Sep. 30, 2004 and Japanese Patent Application No. 2005-122721 filed on Apr. 20, 2005, and the contents thereof are incorporated herein by reference.

### INDUSTRIAL APPLICABILITY

According to the present invention, there can be provided an optical element that is capable of allowing light, which results from excitation by incident light to be emitted through at least one of the front and rear sides of the optical element in the form of linearly polarized light having a sufficient degree of polarization and that is prepared without occurrence of defective appearance and is capable of easily enhancing the luminance of emitted light, as well as a polarized-light-emitting planar light source using the optical element and a display device using the same.

1. An optical element comprising:
a translucent resin;
minute regions dispersedly distributed in the translucent resin and having a birefringence different from the translucent resin; and
at lest one kind of luminous body dispersed in the translucent resin and/or the minute regions and having a particle size smaller than the emission wavelength thereof,
the optical element having a plate-like shape.

2. The optical element according to claim 1,
wherein the luminous body is an inorganic pigment.

3. The optical element according to claim 1,
wherein the luminous body is a fluorescent pigment absorbing ultraviolet light or visible light and emitting visible light.

4. The optical element according to claim 1,
wherein the luminous body is a phosphorescent pigment absorbing ultraviolet light or visible light and emitting visible phosphorescence.

5. The optical element according to claim 1,
wherein the particle size of the luminous body is not more than one fifth of the emission wavelength of the luminous body.

6. The optical element according to claim 1,
wherein the diameter of aggregate formed by aggregating the luminous body is smaller than the emission wavelength of the luminous body.

7. The optical element according to claim 1,
wherein the translucent resin and the minute regions both are made of materials substantially not absorbing ultraviolet light.

8. The optical element according to claim 1,
wherein the minute regions are at least one selected from the group consisting of:
a liquid crystalline material;
a glass state material formed by cooling and fixing a liquid crystal phase; and
a material formed by crosslinking and fixing a liquid crystal phase of a polymerizable liquid crystal with an energy ray.

9. The optical element according to claim 1,
wherein the minute regions are liquid crystal polymer having a glass transition temperature of 50° C. or higher and exhibiting a nematic liquid crystal phase at a temperature lower than the glass transition temperature of the translucent resin.

10. The optical element according to claim 1,
which satisfies the following relations:
0.03≦Δn1≦0.5
0≦Δn2≦0.03
0≦Δn3≦0.03
provided that:
Δn1 is the difference of refractive indices between the translucent resin and the minute regions in an axial direction of the minute regions along which the difference between the translucent resin and the minute regions indicates the maximum value; and
Δn2 and Δn3 are differences of refractive indices between the translucent resin and the minute regions in axial directions each orthogonal to the axial direction along which the maximum value is indicated.

11. A polarized-light-emitting planar light source comprising:
the optical element according to claim 1; and
an excitation light source emitting a light of a wavelength being capable of exciting the luminous body dispersed in the optical element.

12. The polarized-light-emitting planar light source according to claim 11,
wherein the translucent resin and the minute regions both are made of materials substantially not absorbing ultraviolet light, and
the light of a wavelength being capable of exciting the luminous body dispersed in the optical element is ultraviolet light.

13. The polarized-light-emitting planar light source according to claim 11,
which further comprising a light guide member made of a translucent material.

14. The polarized-light-emitting planar light source according to claim 11,
wherein the excitation light source is an inorganic or organic electroluminescent element or a mercury-free fluorescent tube.

15. A display device comprising the polarized-light-emitting planar light source according to claim 11.
